(19) United States
(12) Patent Application Publication
(10) Pub. No.: US 2010/0033433 A1
(43) Pub. Date: Feb. 11, 2010

(54) DISPLAY SYSTEM AND METHOD WITHIN A REDUCED RESOURCE INFORMATION HANDLING SYSTEM

(75) Inventors: James R. Utz, Round Rock, TX (US); Andrew T. Sultenfuss, Leander, TX (US)

Correspondence Address: LARSON NEWMAN & ABEL, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/188,994

(22) Filed: Aug. 8, 2008

(51) Int. Cl. G06F 3/02; G06F 3/033

(52) U.S. Cl. 345/168; 345/184

(57) ABSTRACT

A display system within a reduced resource information handling system is disclosed. In a particular form, a method of outputting video is disclosed. The method can include detecting an operating condition of an internal display and an external display of an information handling system. The information handling system can include a host processing system and a remote processing system. The method can further include detecting a video output signal configured to be displayed during a reduced operating state of the host processing system. The method can also include coupling the video output signal to either the internal display or the external display.

### FIELD OF THE DISCLOSURE

This disclosure relates generally to information handling systems, and more particularly to a display system and method within a reduced resource information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can be configured to use a variety of hardware and software components that can be configured to process, store, and communicate information and can include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a functional block diagram of an information handling system configured to employ an external display using a reduced resource operating environment according to an aspect of the disclosure;

FIG. 2 illustrates a functional block diagram of an information handling system employing a display module configured to output video during a reduced operating state according to an aspect of the disclosure;

FIG. 3 illustrates a flow diagram of a method of enabling video outputs using a display module according to an aspect of the disclosure;

FIG. 4 illustrates a functional block diagram of a remote processing module according to another aspect of the disclosure;

FIG. 5 illustrates a functional block diagram of a host processing system employing a host interface configurable to be coupled to a remote processing module according to an aspect of the disclosure; and

FIG. 6 illustrates a functional block diagram of an external display and user interface deployed within a reduced resource enabled information handling system according to an aspect of the disclosure.

The use of the same reference symbols in different drawings indicates similar or identical items.

### DETAILED DESCRIPTION OF DRAWINGS

The following description in combination with the figures is provided to assist in understanding the teachings disclosed herein. The following discussion will focuses on specific implementations and embodiments. This focus is provided to assist in describing the teachings and should not be interpreted as a limitation on the scope or applicability of the teachings. However, other teachings can certainly be used in this application. The teachings can also be used in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

Portions of an information handling system, when referred to as a “device,” a “module,” or the like, can be configured as hardware, software (which can include firmware), or any combination thereof. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be software, including firmware embedded at a device, such as a Pentium class or PowerPC™ brand processor, or other such device, or software capable of operating a relevant environment of the information handling system. The device could also be a combination of any of the foregoing examples of hardware or software. Note that an information handling system can include an integrated circuit or a board-level product having portions thereof that can also be any combination of hardware and software.

Devices or programs that are in communication with one another need not be in continuous communication with each other unless expressly specified otherwise. In addition, devices or programs that are in communication with one another may communicate directly or indirectly through one or more intermediaries.

Embodiments discussed below describe, in part, distributed computing solutions that manage all or part of a communicative interaction between network elements. In this context, a communicative interaction may be intending to send information, sending information, requesting information, receiving information, receiving a request for information, or any combination thereof. As such, a communicative interaction could be unidirectional, bidirectional, multi-directional, or any combination thereof. In some circumstances, a communicative interaction could be relatively complex and involve two or more network elements. For example, a communicative interaction may be “a conversation” or series of related communications between a client and a server—each network element sending and receiving information to and from the other. The communicative interaction between the network elements is not necessarily limited to only one specific form. A network element may be a node, a piece of hardware, software, firmware, middleware, another component of a computing system, or any combination thereof.

In the description below, a flow charted technique may be described in a series of sequential actions. Unless expressly stated to the contrary, the sequence of the actions and the party performing the actions may be freely changed without departing from the scope of the teachings. Actions may be added, deleted, or altered in several ways. Similarly, the actions may be re-ordered or looped. Further, although processes, methods, algorithms or the like may be described in a sequential order, such processes, methods, algorithms, or any combination thereof may be operable to be performed in alternative orders. Further, some actions within a process, method, or algorithm may be performed simultaneously during at least a point in time (e.g., actions performed in parallel), can also be performed in whole, in part, or any combination thereof.

As used herein, the terms “comprises,” “comprising,” “includes,” “including, “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single device is described herein, more than one device may be used in place of a single device. Similarly, where more than one device is described herein, a single device may be substituted for that one device.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the computing, electronics, and software arts.

An information handling system and method of using it are described below. An exemplary, non-limiting system description is described before addressing methods of using it. Some of the functionality of modules within the system is described with the system. The utility of the system and its modules will become more apparent with the description of the methods that follow the description of the system and modules.

According to an aspect of the disclosure, a display module is disclosed. The display module can include a display configured to be coupled along an external portion of a housing of an information handling system. The display module can further include a display module interface configured to be coupled to a video multiplexer of a host processing system of the information handling system. According to an aspect, the host processing system can be configured to receive a video output signal from a remote processing system.

According to another aspect of the disclosure, a method of outputting video is disclosed. The method can include detecting an operating condition of an internal display and an external display of an information handling system. The information handling system can include a host processing system and a remote processing system. The method can further include detecting a video output signal configured to be displayed during a reduced operating state of the host processing system. The method can also include coupling the video output signal to either the internal display or the external display.

According to a further aspect of the disclosure, an information handling system is disclosed. The information handling system can include a housing configured to store electronics of a host processing system and a remote processing system. The information handling system can also include an external display integrated along an exterior portion of the housing. According to an aspect, the external display can be configured to output a video signal during a reduced operating state of the host processing system.

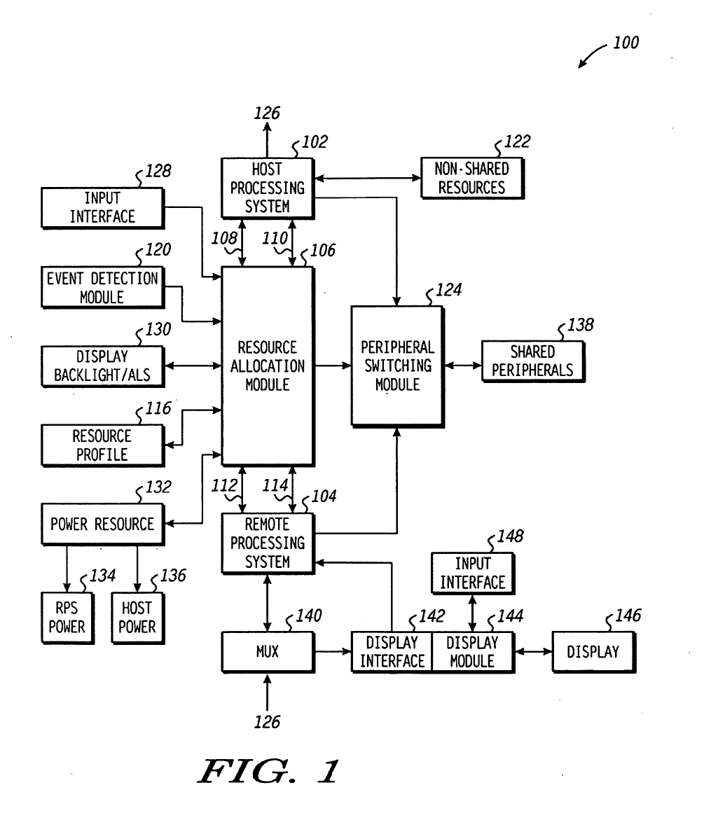

FIG. 1 illustrates a functional block diagram of an information handling system configured to employ an external display using a reduced resource operating environment according to an aspect of the disclosure. The information handling system, generally depicted at 100, can include a host processing system 102 that can include a host CPU, a host CPU chipset, memory, and a host operating system and various other resources and components which can be combined to form an information handling system (not illustrated). The host processing system 102 can also include BIOS (not illustrated) operable to enable resources accessible to the host processing system 102. The information handling system 100 can also include a remote processing system, illustrated generally as remote processing system 104, that can include a CPU, a CPU chipset, memory, and an operating system (not illustrated). The remote processing system 104 can also include a second BIOS (not illustrated) operable to enable resources accessible to the remote processing system 104. In one form, the remote processing system 104 can include BIOS extensions or inputs that can be commonly used by the host processing system 102. The remote processing system 104 can be configured within the same housing of the information handling system 100, such as a laptop housing, notebook housing, or other portable computer system housing.

According to an aspect, the host processing system 102 and the remote processing system 104 can be coupled to a resource allocation module 106. For example, the host processing system 102 can be coupled to the resource allocation module 106 using a bus 108 and a bus 110. In a form, the bus 108 can include a low pin count (LPC) bus and the second bus can include a system management bus (SMBUS). Additionally, the remote processing system 104 can be coupled to the resource allocation module 106 using a bus 112 and a bus 114. In one form buses 108, 110, 112, 114 can include any combination of a personal system 2 (PS2) bus, an RS232 bus, a serial peripheral interface (SPI bus), SMBUS, LPC, or other types of buses, or any combination thereof.

The information handling system 100 can also include an event detection module 118 coupled to the resource allocation module 106 and a resource profile source 120 stored within a memory and accessible to the resource allocation module 106. According to an aspect, the non-shared resources 122 can include local resources that can be local to the host processor 104. Additionally, the non-shared resources 122 can be accessed on a limited basis by the RPM 104. Additionally, the RPM 104 can include the non-shared resources 140 local to the RPM 104 that can be accessed by the host processor 102. According to an aspect, the resource allocation module 106 can maintain a listing of the non-shared resources 122 and 140 of each of the host processor 102 and the RPM 104, and can further enable and disable access to each resource.

The resource allocation module 106 can also be coupled to an input interface 128 that can be coupled to any combination of, a keyboard, pointing device, touchpad, security module, etc. The resource allocation module 106 can also be coupled to a display 130 such as flat screen or flat panel display, touch screen, or any combination thereof. According to an aspect, the display can include a backlight and ambient light sensing (ALS) capabilities. The resource allocation module 106 can further be coupled to a power resource 132 operable to power the MMPM 104 using multi-mode processing module (MMPM) power 134 and to output power to the host processor 104 and associated components using host power 136. Other outputs of the power resource 132 can also be used or enabled. The peripheral switching module 124 can further be coupled to one or more shared peripherals 138 accessible to the MMPM 104 and the host processor 104. The host processing system 102 can also be coupled to non-shared resources 122 and a peripheral switching module 124. The remote processing system 102 can be coupled to non-shared resources 126 and the peripheral switching module 124. The resource allocation module 106 can also be coupled to an input device 128, such as a keyboard, pointing device, or combinations thereof The resource allocation module 106 can also be coupled to a display 130 such as flat screen or flat panel display that can include a backlight and ambient light sensing (ALS) capabilities. The resource allocation module 106 can further be coupled to a power resource 132 operable to power the remote processing system 104 using remote processing system (RPS) power 134 and to output power to the host processing system 104 using host power 136. The peripheral switching module 124 can further be coupled to one or more shared peripherals 136.

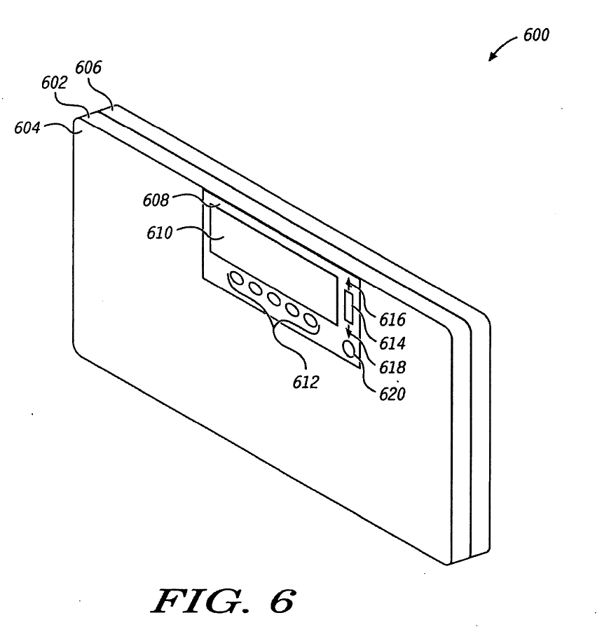

According to a further aspect, the information handling system 100 can include a video multiplexer (MUX) 140 coupled to the remote processing system 104 and operable to multiplex a video signal. The MUX 140 can also be coupled to a display module 144 including a display interface 142, a display 146 and an input interface 148. The display module 144 can output a video output signal to the display 146. According to an aspect, the display module 144 can include display module 608 described in FIG. 6 below. According to an aspect, the display module 144 can include a processor and supporting components.

According to a further aspect of the disclosure, the display 146 can be coupled to an exterior portion of a housing (not illustrated) of the information handling system 100. The display 146 can be enabled during a reduced operating state of the information handling system 100. For example, the remote processing system 104 can be enabled during a reduced operating condition and can further output video to the display 146 using limited resources.

According to a further aspect, the MUX 140 can receive a video input 126 from the host processing system 102. The video input 126 can be multiplexed with a video input from the remote processing system 104, when available if desired, and can be output as a multiplexed video signal from the MUX 140 to the display interface 142. As such, the display 146 can output video signals received from the remote processing system 104, the host processing system 102, during a reduced operating state, a run operating state, or any combination thereof.

In another form, the input interface 148 and the display 146 can be coupled to an external housing of the information handling system 100. For example, the input interface 148 can include one or more input function buttons (e.g. email, calendar, contacts, Internet, etc.) that can be used to access resources of the information handling system 100. In a particular form, the event detection module 118 and the input interface 148 can be used alone, or in combination, to couple an input to the resource allocation module 106.

According to an aspect, the display module 144 can be accessed directly from the RPM 290. However, in other forms, the host processing system 102 can access the display module and display interface 142. In another form, the display interface 142, display module 144, display 16, and input interface 148 can operate as a separate resource that can operate independent to the RPM 104 and the host processing system 102, with the RPM 104, with the host processing system 102, or any combination thereof.

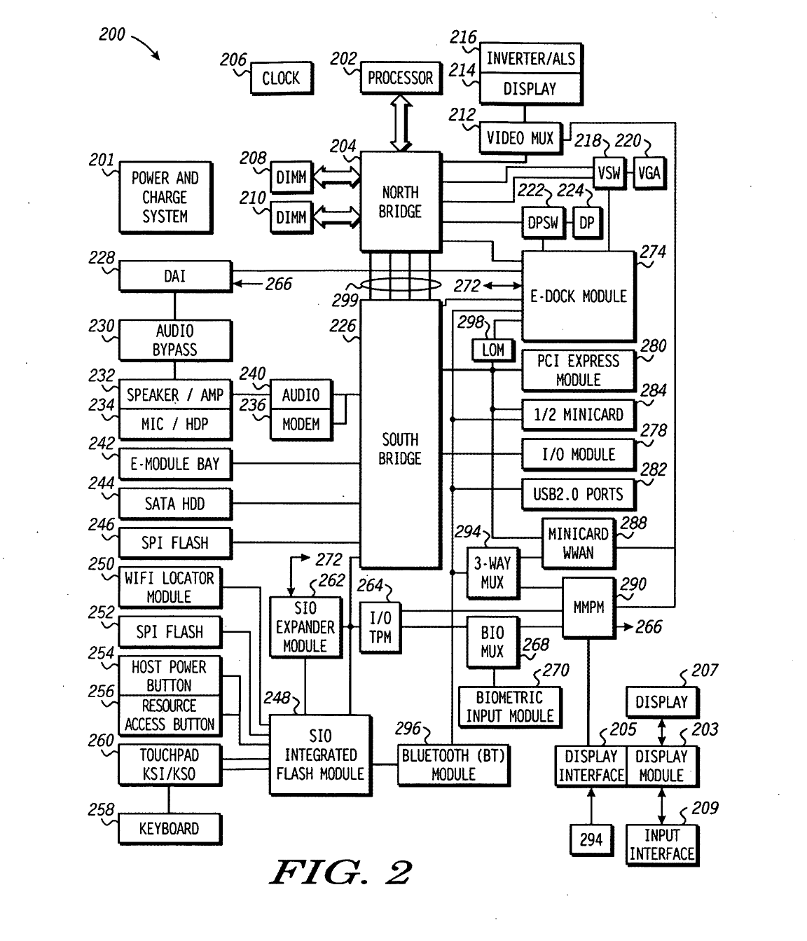

FIG. 2 illustrates a functional block diagram of an information handling system employing a display module configured to output video during a reduced operating state according to an aspect of the disclosure. The information handling system 200 can include a processor 202 coupled to a north bridge 204. A clock 206 can output a timing signal to the processor 202 and other components or resources of the information handling system 200 as needed or required. The north bridge 204 can be further coupled to a dual in-line memory module (DIMM) 208 and a DIMM 210. The north bridge 204 can also be coupled to a video multiplexer (Video MUX) 212 operable to multiplex and output video signals to be displayed using a display 214. The display 214 can include an inverter and automatic light sensor (ALS) module 216. The north bridge 204 can be further coupled to a video switch (VSW) module 218 and a video graphics array (VGA) port 220. A display port (DP) 224 can be coupled to a display port switch (DPSW) 222 operable to be coupled to the north bridge 204, and an E-Dock module 274. The E-Dock module 274 that can be used to expand resources of the information handling system 200, and in various forms, enable access to a battery or charge source, a media slice, an I/O box, a printer interface, or various other resources that can be accessed when docking the information handling system 200 to a docking module.

The information handling system 200 can also include a south bridge 226 coupled to the north bridge 204 using a data bus 299. A digital audio interface (DAI) module 228 can receive a digital audio signal from an input source 266. In an aspect, a remote processing module 290 or other modules can be coupled to the DAI 228 to input a digital audio signal as the input source 266. For example, the DAI module 228 can also be coupled to an E-Dock module 274. An audio bypass 230 can be further coupled to a speaker and amplifier 232, and a microphone and headphone (MIC/HDP) 234. The south bridge 226 can also be coupled to a modem 236 such as an RJ-11 or plain old telephone system (POTS) enabled modem, and an audio output module 240 operable to couple audio output signals using the south bridge 226.

The south bridge 226 can be coupled to the E-Module bay 242which can include a bay or cavity that can be used to enable couple and decouple resources that can access an internal bus of the information handling system 200 and can be further coupled to the south bridge 226. For example, the E-Module bay 242 can be coupled to the south bridge 226 using a multiplexer such as 3-way Mux 294 operable to couple a resource coupled to E-Module bay 242. Examples of resources can include disk drives, optical drives, batteries, I/O expander modules, smart card readers, and various combinations thereof. The information handling system 200 further includes a serial advanced technology attachment hard disk drive (SATA HDD) 244, and a serial peripheral interface (SPI) flash memory 246. The south bridge 226 can also be coupled to a serial I/O (SIO) integrated flash module 248. The SIO integrated flash module 248 can be coupled to a wireless fidelity (WIFI) locator module 250 which can refer to any type of 802.11x or any other short-range wireless communication. The SIO integrated flash module 248 can also be coupled to an SPI flash module 252, a host power button 254, and a resource access button interface 256 that can include one or more resource access buttons. The SIO integrated flash module 248 can also be coupled to a keyboard 258 and touchpad and KSI/KSO module 260. An SIO expander module 262 can also be coupled to the SIO integrated flash module 248 and can further be coupled to an I/O trusted platform module (TPM) 264. The I/O TPM 264 can further be coupled to a biometric multiplexer (BIO MUX) 268, and a biometric input 270 operable to detect user biometrics (e.g. fingerprints, face recognition, iris detection, EKG/heart monitor, etc.). In other forms, the information handling system 200 can also include a security engine (not illustrated) that can be coupled to the biometric inputs using the MMPM 290 that can enable and disable access to portions or all of the information handling system 200.

According to an aspect, the E-Dock module 274 can also be coupled to the SIO integrated flash module 248 and SIO expander module 262 via interface 272. The south bridge 226 can further be coupled to an I/O module 278, a peripheral computer interconnect (PCI) express module 280 using a PCI express bus. The south bridge 226 can further be coupled to universal serial bus (USB) 2.0 access ports 282 via a host USB bus. A ½ Mini Card module 284 and a Minicard wireless wide area network (WWAN) module 288 can also be coupled to the south bridge 226 using a PCI express bus.

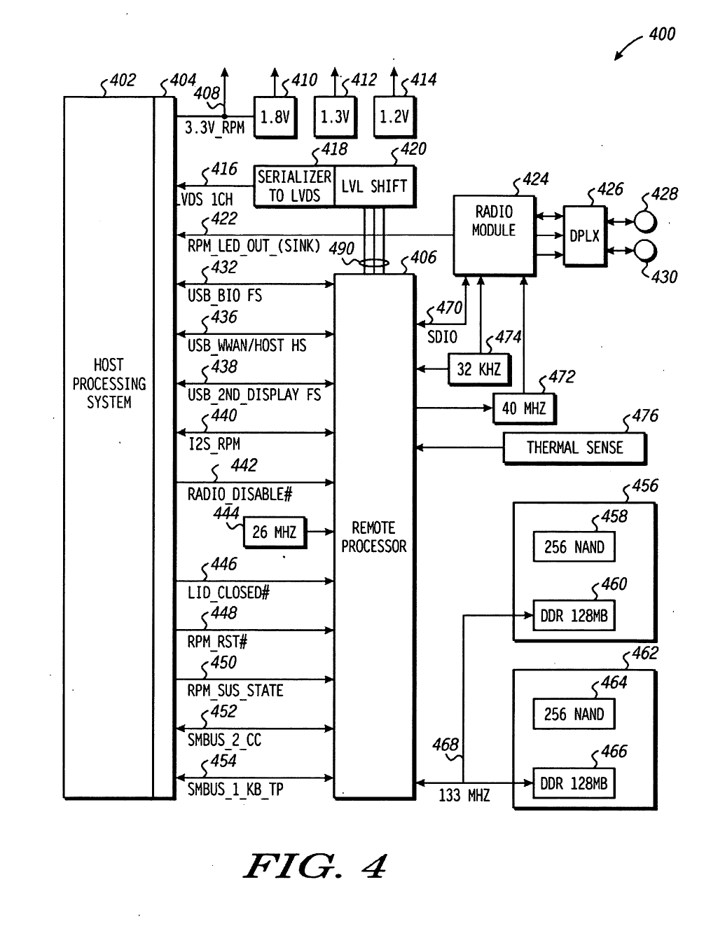

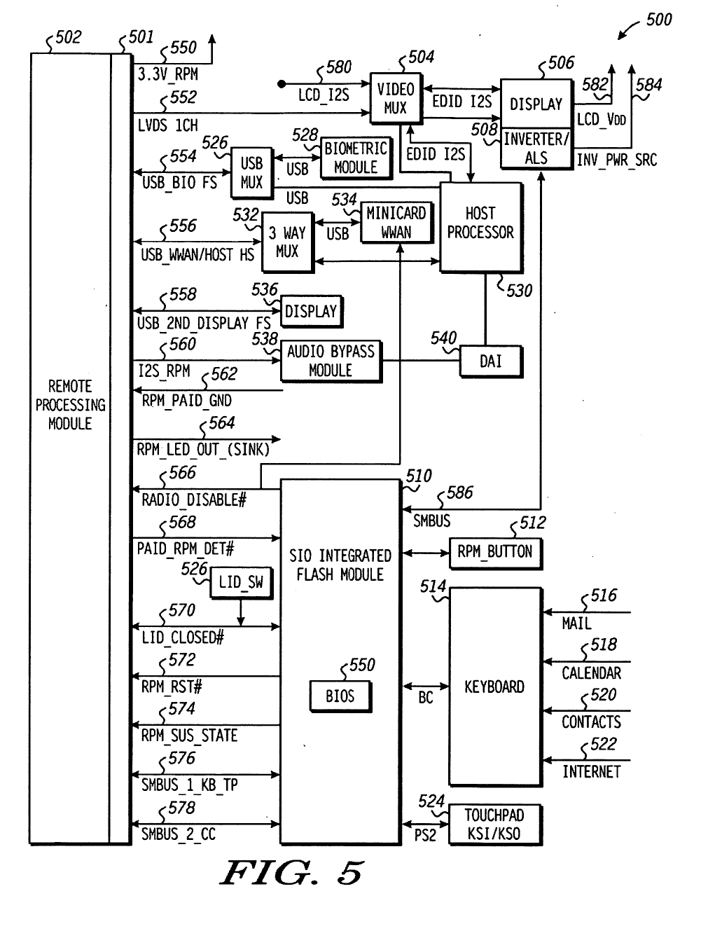

The information handling system 200 can further include a remote processing module (RPM) 290 operable to be coupled to a display 292. RPM 290 can be realized as RPM 104 described in FIG. 1, RPM 400 described in FIG. 4, RPM 502 described in FIG. 5, or any other module operable as needed or desired. RPM 290 can further be configured to output a video signal to the video MUX 212 to output to the display 214. The RPM 290 can also be coupled to a three (3) way multiplexer 294. The three (3) way multiplexer 294 can multiplex USB signals of the Minicard WWAN 288, the RPM 290, and the USB bus coupled to the south bridge 204. The south bridge 226 can further be coupled to a Bluetooth (BT) module 296 via the USB bus. The south bridge 226 can also be coupled to a local area network (LAN) on Motherboard (LOM) 298 via a PCI express bus of the information handling system 200. The LOM 298 can also be coupled to the PCI express module 280. The information handling system 200 also includes a power and charge system 201 operable to distribute power to each component of the information handling system 200, and charge rechargeable power sources of the information handling system 200.

According to a further aspect, the RPM 290 can be coupled to a display interface 205, display module 203 and a display 207. The display interface 205 can further be coupled to the three (3) way MUX 294. The display module 203 can further be coupled to an input interface 209 that can include an array of inputs. According to an aspect, the input interface 209 can include a touch screen interface and controller coupled to the display module 203 and display 207.

According to an aspect, the Minicard WWAN 288 and the RPM 290 can be realized as the same module or device and can be coupled to the information handling system 200 using a Minicard WWAN enabled interface.

During operation, RPM 290 can be configured to detect a user initiated event, a non-user initiated event, network events, clock events, location events, timer events, power events, or any combination thereof. For example, a user initiated event can include a user activating a key, button, or other type of hardware, software, or user selectable interface, or combinations thereof, that can generate a user activated event. For example, a user can select a button to access a messaging application of the information handling system 200. As such, the RPM 290 can detect a request to access the messaging application and the RPM 290 can initiate access to resource of the information handling system 200 during a reduced operating state of the information handling system 200.

According to another aspect, the RPM 290 can detect a non-user initiated event. For example, the information handling system 200 can employ the Minicard WWAN 288 operable to receive communication signals via a wireless communication. The Minicard WWAN 288, coupled to the RPM 290, can detect the non-user initiated event. For example, a software update can be received and an update can be initiated without user intervention. In another form, an auto-power off feature can be used with a GPS feature of the Minicard WWAN 288. The control module 248, the RPM 290, or any combination thereof, can identify a resource profile (not illustrated) of the detected event, and initiate activation of resources of the information handling system 200 to process the non-user initiated event. According to a further aspect, non-user initiated events, user initiated events, or any combination thereof can be detected.

According to an aspect, a resource profile can include a listing of resources of the information handling system 200 sufficient to process an event. The RPM 290 and the control module 248, or any combination thereof, can then initiate activation of resources based on the resource profile using the detected event, and resources available to process the event. As such, the information handling system 200 need not be initialized to process all events, and a limited amount of resources can be activated.

In another form, the information handling system 200 can detect a non-user initiated event communicated to an electronic device other than the information handling system 200 during a reduced operating state of the information handling system 200. For example, the RPM 290 can be configured to detect a message formatted to be received by a smart phone device, Blackberry device, or any type of electronic device configured to receive messages. For example, the information handling system 200 employing the Minicard WWAN 288 operable to detect wireless messages communicated via any network operable to communicate messages. For example, a wireless messaging network such as an SMS network, Blackberry enabled network, or any other type of messaging enabled wireless or wireline network. For example, a wireless messaging network such as an SMS network, Blackberry enabled network, or any other type of messaging enabled wireless or wireline network. In another form, the MMPM 290 can be wirelessly enabled to receive and transmit wireless communication signals. As such, the Minicad WWAN 288 may not be enabled to receive wireless communications.

In an exemplary form, the information handling system 200 can be operating in a low-power operating state that can include sufficient resources to detect a wireless signal. As such, the RPM 290 can determine a current operating state of the information handling system 200, and can initiate enabling resources to process and output a response to the received wireless signal. As such, an operating environment to output a response to a message, such as a Blackberry message, can be enabled using a limited amount of resources without having to initialize additional resources of the information handling system 200. For example, the RPM 290 in combination with the control 248 can be used to enable access to the display 214 to output a received message. Additionally, the keyboard 258 or other input devices of the information handling system 200 can be powered to enable a user to view and respond to a message. As such, a limited resource operating environment can be generated to enable receipt and response to messages without having to initialize the information handling system 200. In this manner, the information handling system 200 can be realized as a laptop or notebook system that can be used to receive messages that may be intended for a Blackberry or other type of messaging device, thereby allowing a user to view messages using a larger display relative to the Blackberry device or smart phone device, and draft and respond to messages using the keyboard 258 and the display 214 as desired.

The information handling system 200 can also include a display module 203, a display interface 205, a display 207, and an input interface 209. The display interface 205 can further receive an input from 3-way MUX 294 operable to generate a multiplexed signal that can include a multiplexed video signal. In other forms, the display interface 205 can receive a video input from RPM 290 and can further couple input signals to the RPM 290 from input interface 209. For example, a user can select a function button (not illustrated) at the input interface 209, and the display module 203 can output the detected input selection to the RPM 290.

According to a particular aspect, the display 207 can be accessed during a reduced operating state of the information handling system 200. For example, the information handling system 200 can be configured as a portable or laptop system. Additionally, the display 207 can be coupled or integrated as a part of a lid portion of the laptop or portable system. FIG. 6 illustrates an example of coupling a display module 203 and display 207 to an external housing. During operation, the laptop can be placed in closed position. However, the display 207 and the input interface 209 can be enabled, and can be configured to output video data that can include email data, contact information, calendar information, meeting data, reminders, alarms, other suitable information, or any combination thereof etc.

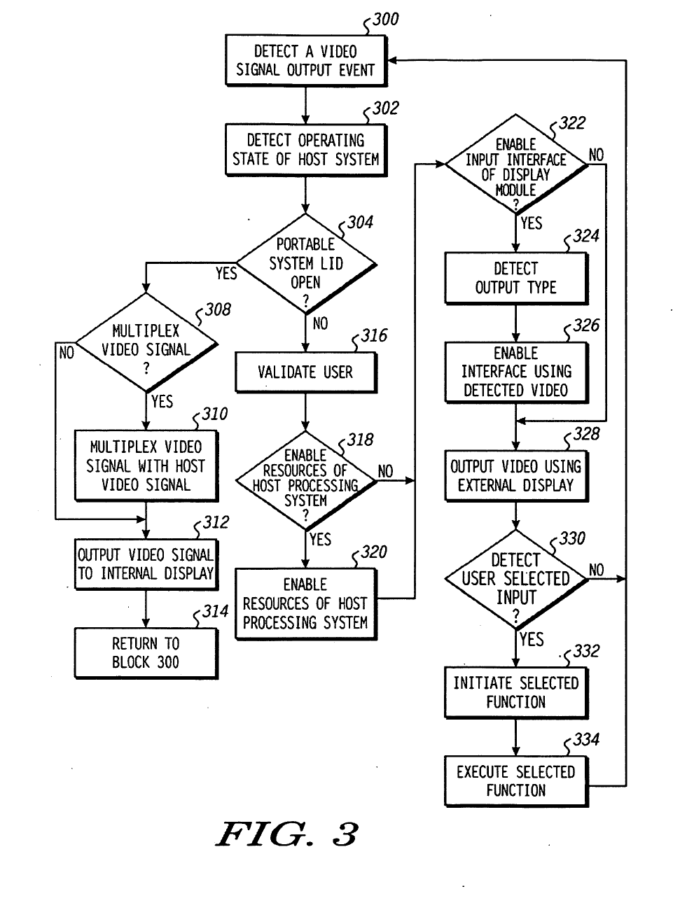

FIG. 3 illustrates a flow diagram of a method of enabling video outputs using a display module according to an aspect of the disclosure. FIG. 3 can be employed in whole, or in part, by the information handling system 100 depicted in FIG. 1, the information handling system 200 described in FIG. 2, the remote processing module 400 described in FIG. 4, the information handling system 500 illustrated in FIG. 5, or any other type of system, controller, device, module, processor, or any combination thereof, operable to employ all, or portions of, the method of FIG. 3. Additionally, the method can be embodied in various types of encoded logic including software, firmware, hardware, or other forms of digital storage mediums, computer readable mediums, or logic, or any combination thereof, operable to provide all, or portions, of the method of FIG. 3.

The method begins at block 300, and when a video signal output event may be detected. For example a video signal output event can include an email message event, Blackberry message event, meeting event, or various other events that may initiate access to a display of a host information handling system to output a video signal. Upon detecting a video signal output event, the method can proceed to block 302 and an operating state of the host system can be detected. For example, an information handling system can be placed in a reduced power state, such as a hibernate state, standby state, or other reduced power states.

The method can then proceed to decision block 304, and a lid or cover to a portable system (e.g. opened or closed) can be detected. For example, an information handling system such as a portable computer or laptop system can include a lid that can be opened or closed, and display video in response to a lid being opened or closed. If at decision block 304, a lid is in an open position, the method can proceed to decision block 308, and a multiplexing the video signal with a host video signal can be detected. For example, the video signal can originate from a remote processing module or other source. As such, the video signal can be multiplexed with a host system video signal at block 310, and output at block 312. If the video signal is not to be multiplexed, the method can proceed to 312 and output the video signal to an internal display of the information handling system. The method can then proceed to block 300 and repeats as needed or desired.

If at decision block 304, the lid is not in the open position (e.g. closed, lowered, etc.), the method can then proceed to block 316 and validates a user if needed or desired. For example, a display module coupled to an external portion of a portable system can include keys, a biometric input device, or various other user interfaces that can be used to validate a user, or any combination thereof. According to another aspect, the method can be modified to output an audio signal, beep, or other output to indicate to a user that a video output event is detected. As such, a user can enter a security code, provide a biometric input, etc. to enable access to the external display module.

The method can then proceed to decision block 318, and enabling resources of a host processing system can be detected. For example, resources can be enabled at the host system based on an operating state of the host system. For example, the method can proceed detect a video class or application to use to output the video using the external display. As such, if no other resources should be enabled, the method can proceed to block 322 as described below. If at decision block 318, additional or other resources should be enabled, the method can proceed to block 320 and enable resources of the host processing system.

At decision block 322, enabling an input interface of the display module can be detected. For example, the external display can be configured as a part of a display module having an interface that can allow a user to select functions to manipulate content displayed within the external display, access additional information, access resources, applications, or any combination thereof. If at decision block 322, an input interface of a display module is not be enabled, the method can proceed to block 328 as described below. If at decision block 322, an input interface is to be enabled, the method can proceed to block 324, and detects video to output, an associated application such as a messaging application, email application, Internet browser application, attachment readers, such as a .pdf file reader, video application, picture viewing application, to activate, or any combination thereof. According to a particular embodiment, a specific file reader, application, or combination thereof, to enable can be detected and enabled in association with outputting the video signal.

Upon enabling an interface if desired, the method can proceed to block 328 and outputs the video using the display. For example, the external display can be configured as a reduced size display (relative to the internal display) and the video content can be modified to be displayed using the reduced size display. Upon outputting the video using the external display, the method can proceed to decision block 330 detects whether a user selected an input. If a user input is not selected, the method can continue to display the video output, and proceeds to block 300 upon detecting a video output signal event. In a particular form, the video output can be display over a limited period of time (e.g., 30 seconds, 60 seconds, etc.), and the external display can return to a sleep state or reduced energy operating state.

If at decision block 330, a user input may be detected, the method can proceed to block 332 and initiates the selected function. For example, a user may elect to dismiss a reminder, delete, reply, forward, etc. an email or other message, read or display an attachment, games, review schedule or calendar information, clock showing date and time, touch/keypad access with security numbers to access the system, location identification and display using GPS, Windows based gadgets, alarms, pre-boot display and authentication upon validating a user to boot the host system without requiring the user to enter additional credentials or biometrics, or various other resources or functions that can be enabled using the display module.

Upon detecting a user selected input, the method can proceed to block 332 and initiates the selected function. For example, additional resources of the host processing system can be enabled in association with the selected function. As such, additional resource can be enabled at block 332, and the method can proceed to block 334 and executes the selected function. Upon executing the function, the method can proceed to block 300 and repeats as needed or desired.

FIG. 4 illustrates a functional block diagram of a remote processing module 400 employing an interface 401 configured to be coupled to a host processing system 402 according to an aspect of the disclosure. For example, a wireless messaging network such as an SMS network, Blackberry enabled network, or any other type of messaging enabled wireless or wireline network. In another form, the MMPM 290 can be wirelessly enabled to receive and transmit wireless communication signals. As such, the Minicad WWAN 288 may not be enabled to receive wireless communications. The remote processing module 400 can include the RPM 104 described in FIG. 1, the RPM 290 described in FIG. 2, or any other module that can be coupled to a host interface 402 to enable access to an information handling system.

According to an aspect, the remote processing module 400 can include a remote processor 406 such as a Texas Instruments (TI) OMAP 2430, 3430, Nvidia AP10, AP15, Motorola I.MX 32, 51, or any other processor that can be used as a processor within the RPM 400. The remote processing module 400 can also include a 3.3 Volt input signal 408 coupled input from the host processing system 402 via the interface 404. The 3.3 Volt input signal can be used to generate a 1.8 Volt signal 410, a 1.3 Volt signal 412, and a 1.2 Volt signal 414 to power various components of the remote processing module 400.

According to a further aspect, the interface 404 can output a low voltage display signal (“LVDS ICH”) 416 output by a serializer-to-LVDS module 418 and a level (LVL) shift module 420. For example, the serializer to LVDS module and LVL shift module 420 can be operable to convert signals from a parallel type input 490 coupled to the LVL shift 420, to a serialized output using the serializer-to-LVDS module 418. Although described as an LVDS 1 CH signal, an LVDS 2 CH signal, or any combination thereof can be output. According to another aspect, a display port, a high definition media interface (HDMI) enabled port, or any combination thereof can be also used, and signals output can be converted as needed or desired. The LVL shift module 420 can be coupled to the remote processor 406 via a data bus 490. The interface 404 can further include a radio synch signal (“RPM_LED_OUT_(Sink)”) 422 output by a radio module 424. The radio module 424 can be configured as a WIFI (e.g. B, G, etc.) radio and can be coupled to a duplex module 426 operable to receive signals from a first antenna 428 and a second antenna 430. The radio module 424 can be integrated as a part of the remote processor 406, or in other forms can accessed as a resource of the remote processor 406. According to a further aspect, the duplex module 426 can be configured to duplex signals of the antenna 428 and the antenna 430. For example, each antenna 428 and 430 and can be activated and deactivated independently or in combination, and used via the radio module 424 in response to an operating condition of the remote processor 406 and a desired signal to be sent or received.

The Interface 404 can also include a USB link operable to communicate a USB bio signal (“USB_BIO FS”) 432 between the Interface 404 and the remote processor 406. The Interface 404 can also be used to couple a WWAN—Host signal (“USB_WWAN/HOST HS”) 436 to the remote processor 406 using a USB link. The Interface 404 can also be used to couple a secondary display signal (“USB_{—}2nd_display FS”) 438 to the remote processor 406 using a USB link.

The interface 404 can also be used to couple a 12S enabled signal (“I2S_RPM”) 440 to the remote processor 406. The interface 404 can also be used to couple a radio disable input signal (“Radio_disable#”) 142 to the remote processor 406. The remote processor 406 can receive a twenty-six megahertz clock signal 444 from a local crystal or other clocking device. The interface 404 can also couple additional signals to the remote processor 406 that can include a reset signal (“RPM_RST#”) 448, The interface 404 can also couple additional signals to the remote processor 406 that can include a reset signal (“RPM_RST#”) 448 can be used to reset the module 400, components within, or any combination thereof. The RPM_RST# signal 448 can also be used to reset the host processing system 402, and components thereof. The RPM_RST # signal 448 can be enabled as a shared signal or as a non-shared signal accessible by the host processing system 402, the remote processor 406, or any combination thereof. A “RPM_SUS_State” signal 450 can include a suspend signal to alter a state of the RPM 400 and can be used to enable or recover from a suspend state. For example, the RPM 400 can be placed in a suspend state and recoverable using the RPM_SYS_State signal 450. In another form, the RPM_SYS_State 450 signal can be used to enable the host system 402 or components thereof. The RPM_SYS State 450 can be enabled as a shared signal or as a non-shared signal accessible by the host system 402, the local processor 406, or any combination thereof.

According to a further aspect, a the interface 404 can include a “SMBUS_{—}2_CC” signal 452 that can be used as a command control bus operable to couple control information between the host processing system 402 and the remote processor 406. The SMBS_{—}2_CC signal 452 can be used to control audio volume, LCD brightness, etc. of the host processing system 402. The interface 404 can also include a “SMBUS_{—}1_KB_TP” signal 454 operable to be couple keyboard touchpad interface signals that can be read by a controller of a keyboard, touchpad, etc. and converted and coupled to the remote processor 406. According to a further aspect, the remote processor 404 can access a resource module 456 including 256K NAND memory 458 and 128 MB of DDR memory 460. The remote processor 406 can also be coupled to a resource module 462 including 256K NAND memory 464 and 128 MB of DDR memory 466. Each resource module 456 and 462 can be coupled to the remote processor 406 using a 133 MHz data bus 468. Other memory sizes and bus speeds can also be used.

According to an aspect, the remote processor 406 can also detect a selection and can access a function, such as an email, calendar, contacts, etc. application accessible to the remote processor 406. For example, various applications can be stored within resource module 456, resource module 462, or any combination thereof. For example, various applications or peripheral sources can include PC radio emulations, transcoders, encryption applications, GPS applications, biometric applications, camera applications, USB concentrator applications, Voice-Over-Internet Protocol (VOIP) applications, persistent hardware assisted virtual management, wake events, system management applications, one or more operating systems, file systems, various other peripheral resource applications and devices, patches, virus scanning software, security applications, or any combination thereof.

According to a further aspect, the remote processor 406 can also be coupled to the radio module 424 using an secure digital I/O (SDIO) bus 470. The remote processor 406 can further output a 40 MHz clock signal 472 that can be coupled to the radio module 424. A 32 KHz signal 474 can further also be coupled to the radio module 424 and the remote processor 406 to synchronize signal timing. A thermal sense input 476 can also be coupled to the remote processor 406 to monitor operating temperature of the remote processing module 400.

According to a particular aspect, the remote processor 406 can be used to output a video output signal to be displayed using an external display of the host processing system 402. For example, the remote processor 406 can format a video output and output a video output signal using the secondary display signal 438. As such, the secondary display signal 438 can couple the video output signal to the host processing system 402 to be displayed using an external display. In this manner, the remote processor 406 can be used during a reduced operating state of the host processing system 402 to output video.

According to another aspect, the remote processor 406 can receive an input from an input interface of a display module such as the display module 144 illustrated in FIG. 1. The remote processor 406 can detect a selection and can access a function, such as an email, calendar, contacts, etc. application accessible to the remote processor 406. For example, various applications can be stored within resource module 456, resource module 462, or any combination thereof.

The remote processor 406 can also detect when the lid of the host processing system 402 is opened or closed using the lid status (“LID_closed #”) 446. For example, the host processing system 402 can include a laptop or other portable system that includes a lid with a display integrated along an internal portion. As the lid is opened, the host processing system 402 can couple an input using lid status 446 to the remote processor 406, and the remote processor can couple a video output signal to be output using the LVDS 1CH signal 416. As a user closes the lid, a signal can be coupled to the lid status 446 indicating that the lid has been closed. The remote processor 406 can couple a video output signal to the second display signal 438. In this manner, a second display, such as an external display provided along an external portion of the housing of the host processing system 402 can output a video output signal as the lid is closed.

FIG. 5 illustrates a functional block diagram of a host processing system employing a host interface configurable to be coupled to a remote processing module according to an aspect of the disclosure. An information handling system 500 can employ a host interface 501 configurable to be coupled to a remote processing module 502 according to an aspect of the disclosure. The remote processing module 502 can include the RPM 104 described in FIG. 1, RPM 290 described in FIG. 2, RPM 400 described in FIG. 4, or any other module that can be coupled to a host interface 402 and accessible to the information handling system 500.

According to an aspect, the host interface 501 can be coupled to a video multiplexer 504 operable to multiplex and output a single channel low voltage display signal (LVDS 1 CH) output by the remote processing module 502 to be displayed using the display 506. The information handling system 500 can also include an control module 510 that can include a BIOS 550 operable to be used to initiate various resources of the information handling system 500. The inverter and ALS module 508 can be coupled to the control module 510 via an SMBUS. The control module 510 can also be coupled to a RPM power button 512 operable to initiate a remote processor operating mode of the information handling system 500 using the RPM 502. The control module 510 can also be coupled to a keyboard 514 that can include a qwerty keyboard having a mail button 516, a calendar button 518, a contacts button 520, and an Internet access button 522. Each button 516, 518, 520, and 522, alone or in combination, can be configured as a separate module or a part of another portion of the information handling system 500. The keyboard 514 can also include various other types of function keys as needed or desired. According to an aspect, the display 536 can be a touch screen enabled display and can couple an input to the control module 510.

The information handling system 500 can also include a USB MUX 526 coupled to a biometric module 528 operable to input biometrics of a user. The USB MUX 526 can further be coupled to a host processor 530 of the information handling system 500, and the host interface 501.

In another embodiment, a “NC_LCD_I2S” signal can be coupled directly to the RPM 502 and can be selectively enabled by the RPM module 502 and can be used to identify a type of display installed. For example, a display classification can be determined and read using the LCD_I2S input 580. As such, a video output format can be determined to be output to the display 506. The video MUX 504 couples the multiplexed signal to the display 506 powered by a display power source (“LCD_Vdd”) 582. The display 506 includes an inverter and ALS module 508 powered by an inverter power source (“INV_PWR_SRC”) 584.

The control module 510 can also be coupled to a touchpad 524 that enables use of a pointer or pointing device that can be displayed on the display 506. The control module 510 can also be coupled to a lid switch (“LID_SW”) input 526 operable to alter a signal when a lid or display of the information handling system 500, other type of mobile information handling system, may be opened or closed.

According to a further aspect, the host interface 501 can also include the audio bypass (“I2S_BLT”) input 538 coupled to an audio bypass module 538. The audio bypass module 538 can be coupled to a digital audio interface (DAI) module 540 via an I²S bus. The DAI module 540 can further be coupled to the host processor 530 via the I²S bus.

According another aspect, the host interface 501 can also include various other inputs, outputs, or combinations thereof. For example, the host interface 501 can include a voltage source input (“3.3V_RPM”) 550, a USB enabled biometric link (“USB_BIO FS”) 554, a USB enabled WWAN and host system link (“USB_WWAN/HOST HS”) 556, a USB enabled second display link (“USB_{—}2nd Display FS”) 558, a I²S (“I2S_RPM”) input 560, a ground input (“RPM_PAID_GND”) 562, and an RPI LED (“RPM_LED_Out_(Sink)”) output 564.

The host interface 501 can also include a radio disable (“Radio_disable #”) input 566, a paid detection (“PAID_RPM_DET#”) input 568, a RPM reset (“RPM_RST#”) input 572, a RPM sustain state (“BLT_SUS_State”) input 574, a SMBUS keyboard enable (“SMBUS_{—}1_KB_TP”) link 576, and an SMBUS 2 CC (“SMBUS_{—}2_CC”) link 578.

According to a further aspect, the WWAN access (“USB_WWAN/HOST HS”) link 556 can be coupled to a three (3) way MUX 532. The Minicard WWAN 534 can be configured to be coupled to the host processor 530 using a USB enabled bus. The RPM 502 can also be coupled a display 536 using display (“USB_second display”) link 558.

According to another aspect, the remote processing module 502 can output a video output signal using the LVDS 1CH signal 552. Additionally, the video output signal can be coupled to the video multiplexer 504 to be displayed using the display 506. In another form, the display 506 can be placed in a non-operating mode. For example, the host processor 530 can be placed in a reduced operating state, and the display 506 can also be placed in a reduced operating state. One example can include the lid of a laptop being closed. As such, the remote processor 502 can detect the lid being closed, and couple a vide output signal to the USB_{—}2nd Display FS signal 558 to be output to the display 536. In this manner, the host processor 530 and the display can in a reduced operating state, and the remote processing module 502 can access the display 536 to output a video signal as needed.

According to another aspect, the remote processing module 502 can output a video output signal and an audio output signal during a reduced operating condition of the host processor 530. For example, the remote processing module 502 can output a video output signal to the display 536, and can further output an audio signal to the audio bypass module 538 which can be activated during the reduced operating condition of the host processor 530. In other forms, the audio bypass module 538 and associated components sufficient to output audio can be enabled and disabled in response to a lid of the information handling system being opened and closed.

FIG. 6 illustrates a functional block diagram of an external display and user interface deployed within a reduced resource enabled information handling system according to an aspect of the disclosure. An information handling system configured as a portable computer, generally illustrated at 600, includes a housing 602 having a lid portion 604, and a bottom portion 606 configured to house electronics of the portable computer 600. The portable computer 600 also includes a display module 608 integrated as a part of the lid portion 604. The display module 608 can include a display 610, a series of function buttons 612, a scroll bar or thumbwheel 614 configured to allow a user to navigate up 616 or down 618 and highlight portions of content displayed within the display 610. The display module 608 can also include a select button 620 that allows a user to select a selectable link, application icon, or various combinations of other selectable content displayed within the display 610.

Although illustrated as physical buttons, the function buttons can be provided within the display 610 operable as a touch screen enabled display. In one form, functions can be displayed and updated within the display 610 to allow a user to access multiple functions. In another form, the function buttons 612, the scroll bar of thumbwheel 614, the select button 620, or any combination thereof, can be incorporated as selectable elements displayed within the display 610. For example, the display 610 can include a touch screen that can a navigation controller to allow for expanding views, collapsing views, controlling what is being displayed, zooming in, zooming out, tabbing between elements, or various other navigation techniques that can deployed using touch screen technology.

During use, a user can close the portable system 600, and the portable system 600 can be placed in a reduced operating state. Additionally, the display module 608 can be enabled to allow access to one or more applications of the portable system 600 while the lid portion 604 of the portable system 600 is in a closed position. In a particular form, the display module 608 can remain in a sleep state that includes low power consumption. As an event is detected by the portable system 600, or component within the portable system 600, the display 610 can be activated. Additional resources of the portable system 600 and the display module 608, or any combination thereof can be activated. For example, the remote processing module 290 described in FIG. 2 can detect receipt of an email. As such, the display module 608 can receive a signal from the remote processing module 290 to activate the display 610, and all or portions of the email can be displayed within the display 610. In other forms, additional resources of the display module 608 can also be activated to allow management, access, or navigation of content displayed within the display 610. For example, the function buttons 612, scroll bar or thumbwheel 614, select button 620 or various combinations thereof can be activated. According to another aspect, the display module 608 can be configured to display a limited amount of graphical content. For example the display 610 can include a size sufficient to display subject, sender, date and time information of an email or message received by the portable system 600. In other forms, the display 610 can include a size sufficient to display a list of emails, contacts, appointments, file names, attachments, etc. can be displayed within the display 610 and accessed and selected as needed.

According to another aspect, a reminder message can be displayed within the display 610. For example, the portable system 600 can detect when a user has a meeting scheduled, and can output a message to the display module 608. The display module 608 can output a message using the display 610, and a user can acknowledge, dismiss, snooze, etc. the message using one or more of the function buttons 612, selection button 620, or any combination thereof.

According to a further aspect, a user can access one or more applications using the function buttons 612. For example, each function button can be linked to an application that can be accessed, such as an email application, a calendar application, an Internet access application, a contacts application, or various other applications that can be accessed when the portable system 600 may be in a reduced operating state. For example, the function buttons 612 can be linked to access an Exchange server application (e.g. Microsoft® Exchange Server®, and the like) configured to allow access and management of correspondences, contacts, files stored on a network, a calendar, etc. As such, the function buttons 612 can be used as browser buttons that can be used select specific functions, and can be updated to employ various functions in response to an application being accessed.

In another form, function buttons 612 can be used as security buttons that can be selected to enable access to the display module 608, the portable system 600, or any combination thereof. For example, a user may be required to select a sequence of function buttons 612 to unlock and use the portable system 600. A valid key value can be stored within the display module 608, or another memory device of the portable system 600. Upon a user entering a valid sequence, the user may be granted access to the display module 610 only, or in combination with, the portable system 600 or select resources within the portable system 600.

In another aspect, the display module 608, display 610, or any combination thereof, can be customized using an application of the host system of the portable system 600. For example, the portable system 600 can include an application displayed within the main display (e.g. internal display) of the portable system 600 that will allow customization of content and the format of the external display 610. For example, a “customize external display” application can be used in a similar manner as a “customize desktop” application of a Windows-based operating system that allows customizing a user desktop of an internal display. For example, a user may elect to display the date and time on the external display 610 when the lid portion 604 of the portable system 600 is in a closed position. In another form, a screen saver application can be enabled to display photos, image or other video content using the external display 610. Various other customized inputs can also be enabled as needed or desired.

According to a further aspect, the display module 608 and portable system 600 can be used to access a reader to allow a user to read an attachment of an email or message. For example, a user can receive an attachment with an email message received. As such, the display module 608 can use resources of the portable system 600 to activate a reader that can allow a user to read an attachment of a message displayed within the display window 610. In this manner, a user need not boot or activate the portable system 600 to a full operating state to allow access to resources sufficient to output attachment of a message displayed within the display 610.

Note that not all of the activities described above in the general description or the examples are required, that a portion of a specific activity may not be required, and that one or more further activities may be performed in addition to those described. Still further, the order in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display module comprising:
a display configured to be coupled along an external portion of a housing of an information handling system; and
a display module interface configured to be coupled to a video multiplexer of a host processing system of the information handling system, wherein the host processing system is configured to receive a video output signal from a remote processing system.

2. The display module of claim 1, further comprising:
an input interface configured to receive a user input to manipulate content displayed within the display; and
wherein the display module interface is further configured to couple an input signal to the remote processing system in response to the user input.

3. The display module of claim 2, further comprising a first access button operably coupled to the input interface, wherein the input interface is operable to initiate access to a first resource of the host processing system during a reduced operating state of the host processing system.

4. The display module of claim 2, wherein the display is configured to be enabled when a cover of the host processing system is in a closed position.

5. The display module of claim 4, wherein the display is configured to be disabled when the cover of the host processing system is in an open position.

6. The display module of claim 2, wherein the input interface further comprises:
an email access button configured to access an email application of the remote processing system during the reduced operating state;
a contacts access button configured to access a contacts application of the remote processing system during the reduced operating state;
a calendar access button configured to access a calendar application of the remote processing system during the reduced operating state; and
an Internet access button configured to access an Internet application of the remote processing system during the reduced operating state.

7. The display module of claim 1, wherein the display interface is further configured to receive a video input signal from the remote processing module during the reduced operating state.

8. The display module of claim 1, wherein the display interface is further configured to receive a video input signal from the host processing system during a run operating state of the host processing system.

9. The display module of claim 1, wherein:
the display is a security enabled display operable to output a video output upon validating a user of the information handling system; and
the display is integrated as a part of the housing of the host processing system.

10. A method of outputting video comprising:
detecting an operating condition of an internal display and an external display of an information handling system, wherein the information handling system includes a host processing system and a remote processing system;
detecting a video output signal configured to be displayed during a reduced operating state of the host processing system; and
coupling the video output signal to either the internal display or the external display.

11. The method of claim 10, further comprising:
detecting a closed lid of the information handling system;
enabling the remote processing system;
disabling the host processing system;
enabling the external display; and
outputting the video output signal to the external display.

12. The method of claim 11, further comprising:
enabling an input interface in response to detecting the closed lid;
detecting a user selected input at the input interface;
coupling a input signal to the remote processing system in response to the user elected input; and
enabling a function using the remote processing system.

13. The method of claim 10, further comprising:
detecting a video input signal at the remote processing system during a reduced operating state of the host processing system;
determining whether to output the video input signal to the internal display or the external display; and
outputting the video input signal in response to the determining.

14. The method of claim 12, further comprising:
detecting a reduced operating state of the host processing system; and
enabling the remote processing system to process the user selected input.

15. The method of claim 10, further comprising:
detecting a first video input signal of the host processing system;
detecting a second video input signal of the remote processing system;
multiplexing the first video input signal and the second video signal to generate a multiplex video signal; and
outputting the multiplexed video signal.

16. The method of claim 15, further comprising:
detecting a closed lid of the host processing system;
outputting the multiplexed video signal to the external display in response to detecting the closed lid;
detecting an opening of the closed lid;
enabling the internal display;
disabling the external display; and
outputting the multiplexed video signal to the internal display.

17. An information handling system comprising:
a housing configured to house electronics of a host processing system and a remote processing system; and
an external display integrated along an exterior portion of the housing, wherein the external display is configured to output a video signal during a reduced operating state of the host processing system.

18. The information handling system of claim 17, further comprising:
an internal display operational to display information from the host processing system and the remote processing system when a lid of the housing is in an open position;
wherein the external display is configured to be enabled when the lid of the housing in a closed position; and
wherein the external display is operational to output video of the host processing system and the remote processing system.

19. The information handling system of claim 18, further comprising:
a video multiplexer configured to multiplex a first video signal output from the host processing system with a second video signal output from the remote processing system; and
an input interface operably coupled to the external display including:
a first input configured to access a resource of the host processing system; and
a second input configured to access a resource of the remote processing system.

20. The information handling system of claim 17, wherein the remote processing system is configured to detect when a lid of the housing is in a closed position and to initiate outputting a video received by the remote processing system to the external display.
